(19) United States
(12) Patent Application Publication
(10) Pub. No.: US 2007/0226384 A1
(43) Pub. Date: Sep. 27, 2007

(54) Intelligent Synchronization of Media Player with Host Computer

(76) Inventors: Jeffrey L. Robbin, Los Altos, CA (US); David Heller, San Jose, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 11/757,214

(22) Filed: Jun. 1, 2007

Related U.S. Application Data
(63) Continuation of application No. 10/118,069, filed on Apr. 5, 2002.
(60) Provisional application No. 60/346,235, filed on Oct. 22, 2001.

(51) Int. Cl. G06F 3/00

(52) U.S. Cl. 710/61

(57) ABSTRACT

Improved techniques for synchronization of media contents stored on a media player with media contents stored on a host computer are disclosed. According to one aspect, synchronization can be automatically initiated and performed upon connection of a data link between the media player and the host computer. According to another aspect, synchronization is able to be achieved with a reduced amount of data transfer between the host computer and the media device.

### CROSS-REFERENCE TO RELATED APPLICATIONS

This application is a continuation of U.S. application Ser. No. 10/118,069, filed Apr. 5, 2002, and entitled “INTELLIGENT SYNCHRONIZATION OF MEDIA PLAYER WITH HOST COMPUTER,” which is hereby incorporated herein by reference, which claims the benefit of priority of U.S. Provisional Application No. 60/346,235, filed Oct. 22, 2001, and entitled “INTELLIGENT SYNCHRONIZATION OF MEDIA PLAYER WITH HOST COMPUTER,” which is hereby incorporated herein by reference.

### BACKGROUND OF THE INVENTION

1. Field of the Invention

The present invention relates to media devices and, more particularly, to synchronization or management of media on media devices.

2. Description of the Related Art

Synchronization operations have been conventionally performed between portable devices, such as Personal Digital Assistants (PDAs) and host computers, to synchronize electronic files or other resources. For example, these files or other resources can pertain to text files, data files, calendar appointments, emails, to-do lists, electronic rolodexes, etc. However, such synchronization schemes tend to utilize filenames and modification dates to determine whether files need to be copied between the devices. These synchronization schemes can be largely automated but nevertheless have to be manually initiated.

In the case of media players, such as MP3 players, files are typically moved between a host computer and a media player through use of a drag and drop operation, like is conventionally done with respect to copying of a data file from a Windows desktop to a floppy disk. Hence, the user of the media player manually initiates the synchronization for individual media items. As a consequence, synchronization tends to be tedious and time consuming for users. Synchronization tends to be slow because data is transmitted between devices over a slow link.

Thus, there is a need for improved techniques for improved approaches to synchronize media devices and host computers.

### SUMMARY OF THE INVENTION

Broadly speaking, the invention relates to synchronization of media contents stored on a media player with media contents stored on a host computer (e.g., personal computer). According to one aspect of the invention, synchronization can be automatically initiated and performed upon connection of a data link between the media player and the host computer. According to another aspect of the invention, synchronization is able to be achieved with a reduced amount of data transfer between the host computer and the media device.

The invention can be implemented in numerous ways, including as a method, system, device, apparatus, or computer readable medium. Several embodiments of the invention are discussed below.

As a method for synchronizing media contents of a media player with a host computer, one embodiment of the invention includes at least the acts of: detecting connection of a media player to the host computer; and automatically synchronizing media content between the media player and the host computer once the connection has been detected.

As a portable media player, one embodiment of the invention includes at least: a storage device that stores a plurality of media items; a user input device that enables a user of the portable media player to at least select a particular media item from the plurality of media items; a cache memory capable of storing at least one of the media items; a media database that stores characteristics information for the media items stored to the storage device and the cache memory; and a processor capable of controlling the portable media player to store, remove and play the media items. The portable media player can interconnect with a host computer. The processor can operate to automatically synchronize the media items stored in the storage device with those media items stored at a host computer once the portable media player is connected with the host computer.

As a computer readable medium storing at least computer program code for synchronizing media contents of a media player with a host computer, one embodiment of the invention includes at least: computer program code for detecting connection of a media player to the host computer; and computer program code for automatically synchronizing media content between the media player and the host computer once the connection has been detected.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a synchronization system according to one embodiment of the invention.

FIG. 2 is a block diagram of a media synchronization system according to one embodiment of the invention.

FIG. 3 is a flow diagram of media manager processing according to one embodiment of the invention.

FIG. 4 is flow diagram of synchronization processing according to one embodiment of the invention.

FIGS. 5A and 5B illustrate media device synchronization processing according to one embodiment of the invention.

FIGS. 6A and 6B are flow diagrams of host computer synchronization processing according to one embodiment of the invention.

### DETAILED DESCRIPTION OF THE INVENTION

The invention relates to synchronization of media contents stored on a media player with media contents stored on a host computer (e.g., personal computer). According to one aspect of the invention, synchronization can be automatically initiated and performed upon connection of a data link between the media player and the host computer. According to another aspect of the invention, synchronization is able to be achieved with a reduced amount of data transfer between the host computer and the media device.

According to one embodiment of the invention, the media device is a media player, and the media content on the media player is detailed in a media database residing on the media player. The host computer also stores a media database of the media content on the host computer. Then, on synchronization, the media information stored in the respective media databases can be compared to determine which, if any, media items are to be copied from the host computer to the media player. For example, the media items can pertain to media files for songs, and the media information from the respective databases being compared might include song title, album name and artist name. As a result, the synchronization process is able to be more intelligently performed. Media items can also be removed (or deleted) from the media player if no longer present on the host computer. In other embodiments, media items can additionally or alternatively be copied from the media player to the host computer.

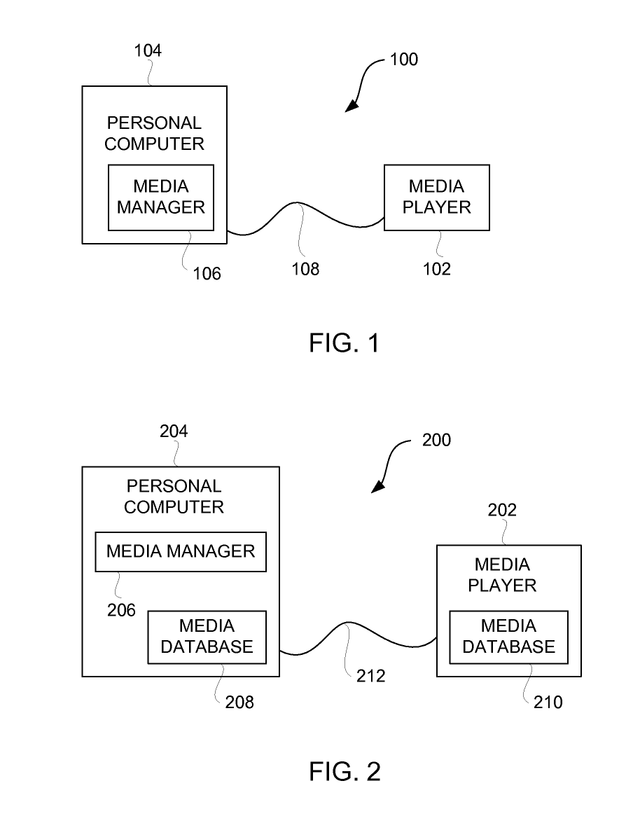

Embodiments of this aspect of the invention are discussed below with reference to FIGS. 1-6B. However, those skilled in the art will readily appreciate that the detailed description given herein with respect to these figures is for explanatory purposes as the invention extends beyond these limited embodiments.

FIG. 1 is a block diagram of a synchronization system 100 according to one embodiment of the invention. The synchronization system 100 includes a media player 102 and a personal computer (host computer) 104. The media player 102 is, for example, a portable, battery-operated device. In one embodiment, the media player 102 is an MP3 player. The personal computer 104 includes a media manager 106. The media manager 106 enables a user of the personal computer 104 to manage media content stored on the personal computer 104. For example, the media manager facilitates a user with browsing, organizing, or other operations with respect to media content (e.g., numerous media items). A peripheral cable 108 couples the media player 102 to the personal computer 104. Typically, the peripheral cable 108 couples together data ports provided on the media player 102 and the personal computer 104. In one example, the data ports can be FIREWIRE ports and the peripheral cable 108 can be a FIREWIRE cable. More generally, the peripheral cable 108 acts as a data link. Media items can be transferred from the media player 102 to the personal computer 104 over the peripheral cable 108, and vice versa.

In one embodiment, the media player is a portable computing device dedicated to processing media such as audio, video or images. For example, the media player 102 can be a music player (e.g., MP3 player), a game player, a video player, a video recorder, a camera, an image viewer and the like. These devices are generally battery operated and highly portable so as to allow a user to listen to music, play games or video, record video or take pictures wherever the user travels. In one implementation, the media player is a handheld device that is sized for placement into a pocket or hand of the user. By being handheld, the media player is relatively small and easily handled and utilized by its user. By being pocket sized, the user does not have to directly carry the device and therefore the device can be taken almost anywhere the user travels (e.g., the user is not limited by carrying a large, bulky and often heavy device, as in a portable computer). Furthermore, the device may be operated by the users hands, no reference surface such as a desktop is needed.

FIG. 2 is a block diagram of a media synchronization system 200 according to one embodiment of the invention. The media synchronization system 200 includes a media player 202 and a personal computer 204. The personal computer 204 includes a media manager 206. The personal computer 204 further includes a media database 208. The media player 202 includes a media database 210. Typically, the media player 202 will also include a data storage device (e.g., disk drive) for storing media content, a cache memory for storing media content in-use, a screen display for displaying information to a user, and a processor (e.g., microprocessor) for controlling operation of the media player 202.

A peripheral cable 212 provides a data path (or data link) between the media player 202 and the personal computer 204. The peripheral cable 212 provides a peripheral bus that couples the media player 202 to the personal computer 204. The peripheral bus, for example, could be a FIREWIRE bus or a Universal Serial Bus (USB). A synchronization operation between the media content stored on the personal computer and the media content stored on the media player 204 can be achieved in a sophisticated manner through comparison of media information stored in the respective media databases 208 and 210. When comparison of the media information from the respective databases 208 and 210 indicates that there is a particular media item resident on the personal computer 204 but not on the media player 202, then the particular media item can be transmitted (downloaded) to the media player over the peripheral cable 212. On the other hand, when the comparison of the media information from the respective databases 208 and 210 indicates that a particular media item is resident on the media player 202 but not on the personal computer 204, then the particular media item can be either removed (deleted) from the media player 202 or transmitted (e.g., uploaded) over the peripheral cable 212 to the personal computer 204. Hence, by providing the media player 202 with the media database 210, more sophisticated synchronization and management of media content is enabled.

The media database 210 also allows the media player 202 to present a user interface to the user that is more sophisticated then conventional approaches. Such a user interface can be presented on the screen display of the media player 202. The user interface can, for example, allow the user of the media player 202 to browse, sort, search, play, etc. the media content resident on the media player 202. The user interface can also allow the user of the media player 202 to download (add) or delete (remove) media items from the media player 202. The media manager 206 also has a user interface that allows a user to browse, sort, search, play, make playlists, burn Compact Discs (CDs), etc. the media content resident on the personal computer 204. The user interface can also allow the user of the personal computer 204 to download (add) or delete (remove) media items from the personal computer 204. In one embodiment, the media manager 206 and its associated user interface are provided by iTunes, version 2.0, from Apple Inc. of Cupertino, Calif.

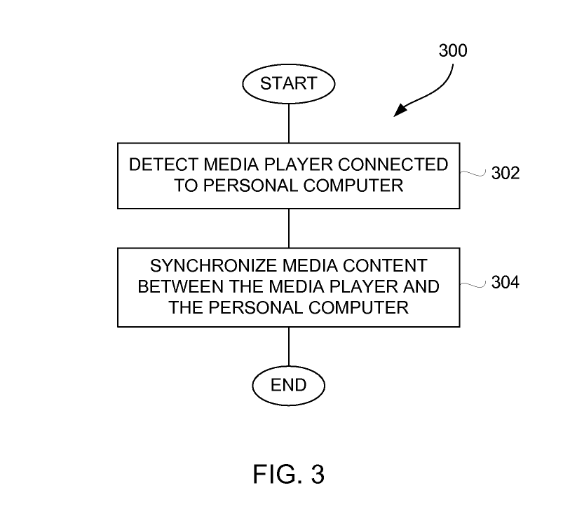

FIG. 3 is a flow diagram of media manager processing 300 according to one embodiment of the invention. The media manager processing 300 is, for example, performed by the media manager 106 illustrated in FIG. 1 or the media manager 206 illustrated in FIG. 2.

The media manager processing 300 initially detects 302 a media player connected to a personal computer (host computer). Here, when a media player is connected to the personal computer, a synchronization operation can be performed to synchronize the media content between the media player and the personal computer. After the media player has been detected as being connected to the personal computer, the media content between the media player and the personal computer can be synchronized 304. The synchronization can be performed in a one-way manner or in a two-way manner. In a preferred embodiment, the synchronization is one-way from the personal computer to the media player. In another embodiment, the synchronization can be one-way from the media player to the personal computer. In still another embodiment, the synchronization can be two-way from the media player to the personal computer as well as from the personal computer to the media player. In any case, the media player typically has less media storage capacity than the personal computer and thus may limit the extent of the synchronization that can be performed. The synchronization processing can be performed manually assuming that a media player has already been detected 302 or automatically upon such detection. In the case of automatic synchronization following detection 302 of the connection, synchronization is performed without a user interacting with any buttons or user interface elements, that is, the connection itself initiates the synchronization.

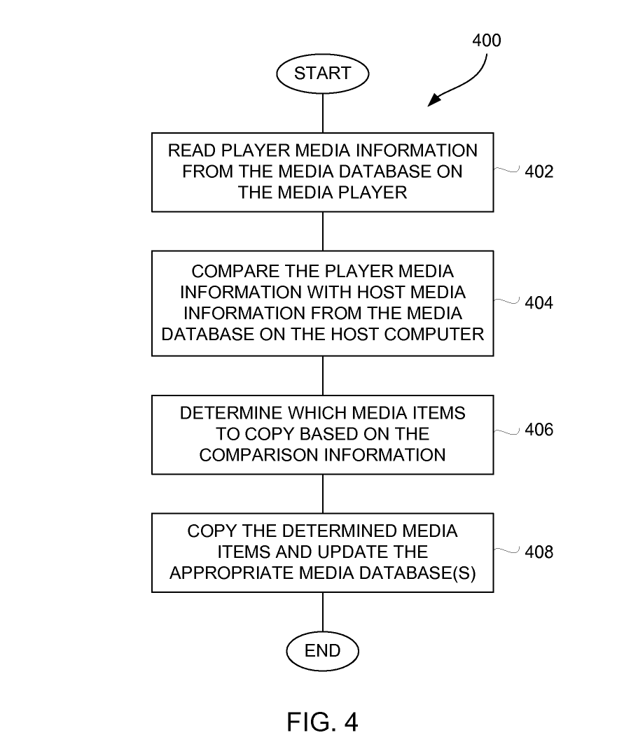

FIG. 4 is flow diagram of synchronization processing 400 according to one embodiment of the invention. The synchronization processing 400 is, for example, performed by a host computer, such as the personal computer 104 illustrated in FIG. 1 or the personal computer 204 illustrated in FIG. 2. More specifically, the synchronization processing 400 is performed by the media manager 106 illustrated in FIG. 1 or the media manager 206 illustrated in FIG. 2.

The synchronization processing 400 initially reads 402 player media information from a media database on a media player. Next, the player media information is compared 404 with first media information from a media database on a host computer. Such comparison produces comparison information concerning differences between the player media information and the host media information. Next, the synchronization processing 400 determines 406 one or more media items to copy between the host computer and the media player based on the comparison information. For example, media items (e.g., audio files for songs) can be compared using media information such as song title, album name and/or artist name which pertain to characteristics or attributes of the media items. Thereafter, the determined one or more media items are copied 408 and the appropriate media database(s) are updated. Following the operation 408, the synchronization processing 400 is complete and ends.

According to one embodiment, the comparison of player media information and host media information is performed using media attributes of the various media items. Namely, a media item on the media player can be deemed the same media item as resident on the host computer if its media attributes sufficiently match. Examples of media attributes include title, album, track, artist, composer and genre. These attributes are particular to a particular media item. In addition, other media attributes can pertain to quality characteristics of the media item. Examples of such media attributes include bit rate, sample rate, equalization setting, volume adjustment, start/stop and total time. Hence, in one embodiment, if the above-identified media attributes pertaining to a media item on the media player all match those same media attributes pertaining to a media item on the host computer, then the two media items stored on different devices can be deemed the same even though still further attributes or characteristics may cause these media items to not be exact duplications of one another. For example, if modification dates associated with respective files storing the media items were different, this difference in modification date would not trigger the copying of such media items from the host computer to the media player when the above-identified media attributes match.

Hence, the intelligence of the synchronization processing of the invention allows the amount of data transfer to be properly managed such that it is relatively low or minimized. Although conventional approaches are able to transfer files from a host computer to a portable device, when dealing with media items, filenames and modification dates tend not to be reliable indicators of whether data transfer needs to be transferred (i.e., copied). As a result, using conventional data transfer techniques with respect to media items results in slow and inefficient operation and thus tends to present an unsatisfactory user experience.

Although the synchronization processing 400 makes use of media databases at the host computer and the media player, in another embodiment. the needed host media information and the player media information can be gathered from the media items themselves. In one implementation, such media information can be acquired from metadata provided with the media items. However, by providing the media databases, synchronization is able to be performed more efficiently and quickly.

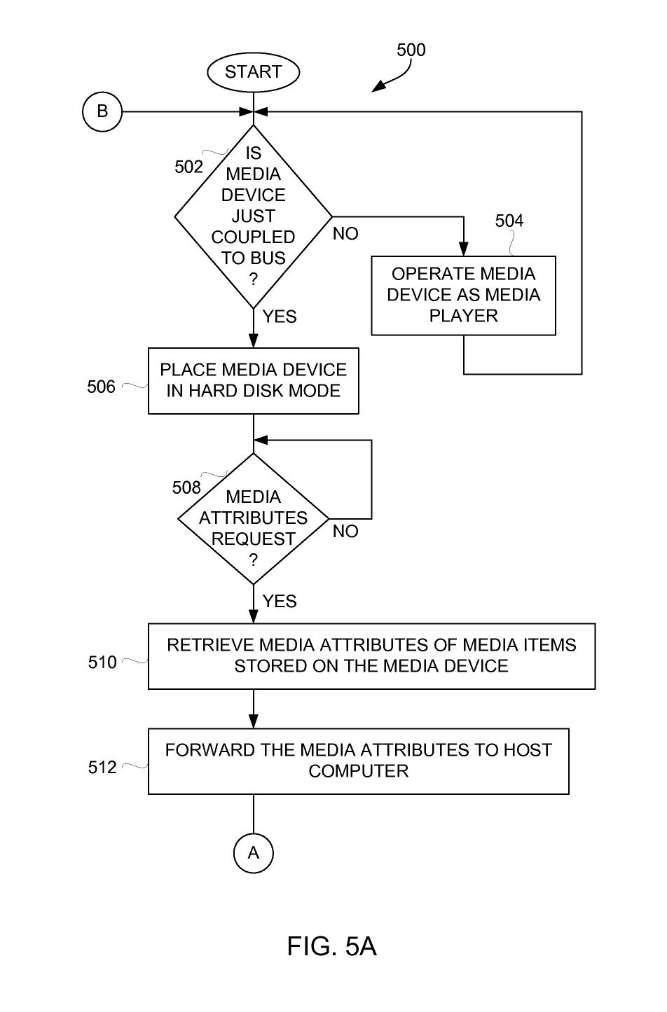

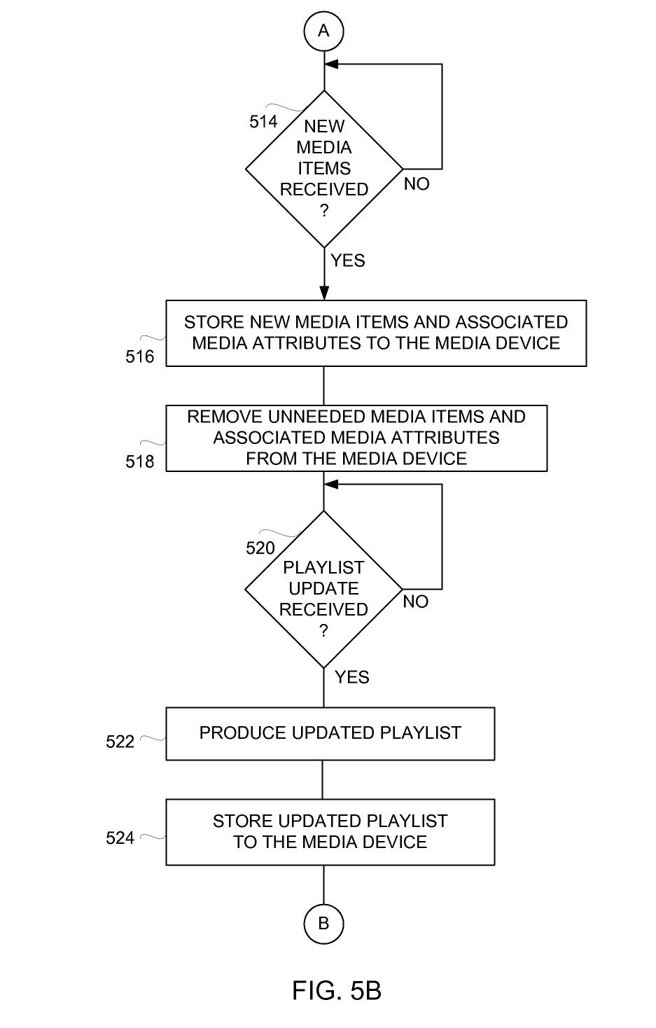

FIGS. 5A and 5B illustrate media device synchronization processing 500 according to one embodiment of the invention. The media device synchronization processing 500 is performed by a media device that interacts with a host computer over a network. For example, the media device can pertain to the media player 102 illustrated in FIG. 1 or the media player 202 illustrated in FIG. 2.

The media device synchronization processing 500 is generally operative on the media device when the media device is powered-on. Initially, a decision 502 determines whether the media device has just been coupled to a bus. The decision 502 can be performed periodically to check for a recent connection to a bus or can be triggered by hardware detection of connection to a bus. The bus is a communication bus coupled to the host computer. In one embodiment, the bus is a serial bus such as FIREWIRE or Universal Serial Bus (USB). When the decision 502 determines that the media device has not just been coupled to a bus, then the media device is operated 504 as a media player. In such a mode, the media device operates to browse, search or play media items for its user. The media items can be audio items (e.g., songs). Following the operation 504, the media device synchronization processing 500 returns to repeat the decision 502 and subsequent operations.

On the other hand, when the decision 502 determines that the media device has just been coupled to the bus, then the media device is placed in a hard disk mode. In the hard disk mode, the media device acts as an external hard drive to the host computer. A decision 508 then determines whether the host computer has requested media attributes for the media items residing on the media device. When the decision 508 determines that the host computer is not requesting media attributes, the media device can, but need not, perform other hard drive operations for non-synchronization purposes (not shown). When the decision 508 determines that the host computer is requesting media attributes (i.e., such as through a read operation), then the media attributes of the media items stored on the media device are retrieved 510. After the media attributes are retrieved 510, the media attributes are forwarded 512 to the host computer.

Next, a decision 514 determines whether new media has been received at the media device from the host computer. In other words, in an effort to synchronize the media content residing on the media device with the media content residing at the host computer, the media device will often receive media content from the host computer. Hence, the decision 514 determines whether new media items have been or are presently being received. When the decision 514 determines that such new media items have not been received, then the media device synchronization processing 500 can await such new media items. While waiting for new media items, the media device can, but need not, perform other hard drive operations for non-synchronization purposes (not shown). More generally, other hard disk operations can occur concurrently with synchronization operations. On the other hand, when the decision 514 determines that new media items have been received from the host computer, then the new media items and their associated media attributes are stored 516 to the media device. In one embodiment, the new media items are stored to files in the media device, and the associated media attributes pertaining to the media items are stored in a media database residing on the media device. Additionally, any unneeded media items and their associated media attributes can be removed 518 from the media device. Hence, in this embodiment, by synchronizing the media content residing on the media device with that on the host computer, new media items are not only stored to the media device, but unneeded (e.g., old) media items and their associated media attributes are also removed from the media device.

Following the operation 518, a decision 520 determines whether a playlist update has been received. When the decision 520 determines that a playlist update has not been received, then the media device synchronization processing 500 can await such a playlist update. Alternatively, when the decision 520 determines that a playlist update has been received, then an updated playlist for the media device is produced 522. The playlist update could be the updated playlist or could be instructions to update an existing playlist. The updated playlist is then stored 522 to the media device.

In effect, one or more playlists at the host computer can be synchronized with the media device and thus made available to the media device. A playlist identifies particular media items that are to be played in a sequence. Internally, the playlist can be represented in the media database as a data structure that points to files of the appropriate media items residing on the storage device within the media device. Hence, for a given playlist, the pointers to the files of the appropriate media items on the media device will differ from the pointers to the files for the same media items on the host computer, thus the need to update the pointers if a particular playlist is moved between the host computer and the media device.

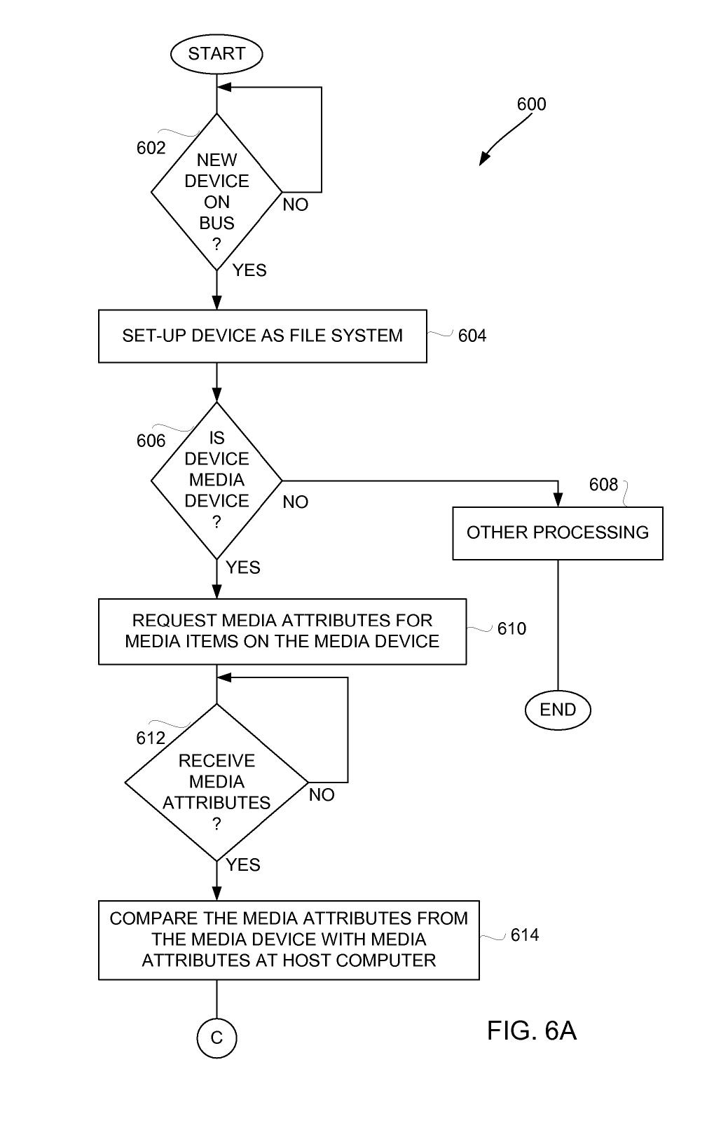

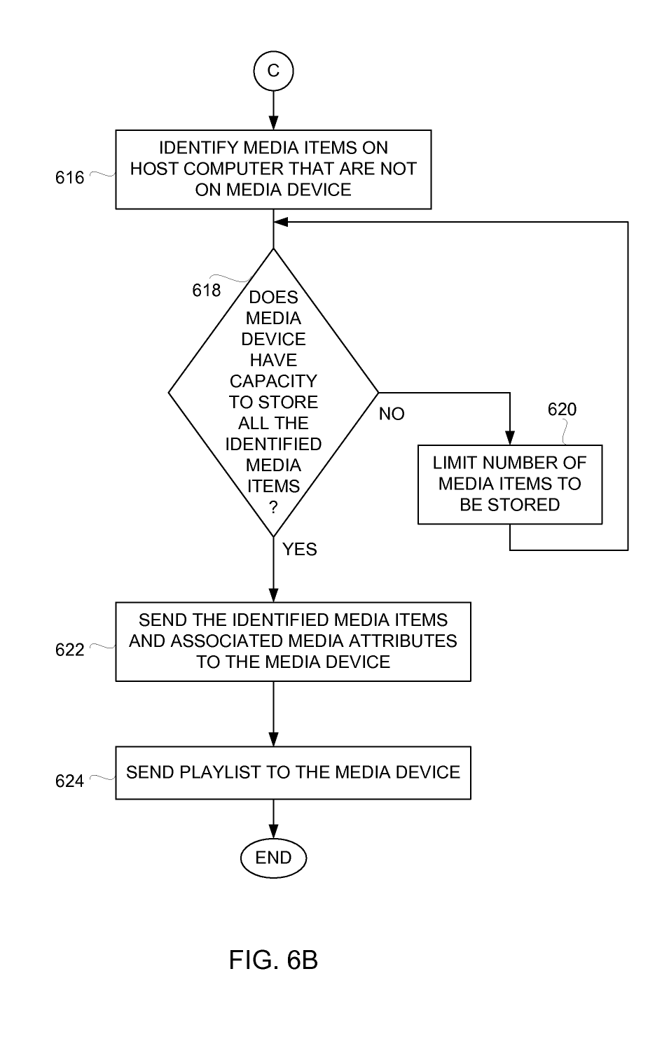

FIGS. 6A and 6B are flow diagrams of host computer synchronization processing 600 according to one embodiment of the invention. The host computer synchronization processing 600 is, for example, performed by a host computer. The host computer can, for example, be the personal computer 104 illustrated in FIG. 1 or the personal computer 204 illustrated in FIG. 2.

The host computer synchronization processing 600 begins with a decision 602 which monitors a bus (i.e., peripheral bus) to determine whether any new devices have been attached. In one implementation, the monitoring is limited to a particular category of devices (e.g., FIREWIRE devices). Such monitoring can, for example, be performed by polling the device(s) on the bus or by receiving a new device alert. When the decision 602 determines that no new devices have been attached to the bus, then the host computer synchronization processing 600 awaits the presence of a new device. Once the decision 602 determines that a new device is present on the bus, then the device is set up 604 as a file system with respect to the host computer. As such, an operating system for the host computer is able to access (read, write and delete) files with respect to the file system (i.e., the new device).

Next, a decision 606 determines whether the device that is now present on the bus is a media device. When the decision 606 determines that the device is not a media device, then other processing 608 can be performed. Such other processing 608 is unrelated to synchronization processing and thus not further described herein. Following the other processing 608, the host computer synchronization processing 600 is complete and ends with synchronization not having been performed.

On the other hand, when the decision 606 determines that the device is a media device, then media attributes for media items on the media device are requested 610. Typically, the media attributes for all the media items residing on the media device would be retrieved. A decision 612 then determines whether the media attributes have been received. When the decision 612 determines that the media attributes have not yet been received, then the host computer synchronization processing 600 can await their receipt. Once the decision 612 determines that the media attributes have been received, then the media attributes from the media device are compared 614 with media attributes for the media items residing on the host computer. Here, the comparison 614 of media attributes with respect to the media device and the host computer results in comparison information. The comparison information indicates directly or indirectly which media items are present at the host computer but not present at the media device as well as which media items are present at the media device but not present at the host computer. Following the comparing 614, the media items on the host computer that are not on the media device are identified 616.

Next, a decision 618 determines whether the media device has the capacity to store all the identified media items. Here, the decision 618 determines whether the media device has sufficient storage capacity to store the one or more media items that have been identified 616 as on the host computer but not on the media device. When the decision 618 determines that the media device does not have sufficient capacity, then the number of media items to be stored is limited 620. There are numerous ways to limit the number of media items to be stored. For example, one or more of the media items to be stored can be unidentified such that it is not to be stored to the media device. The one or more media items to be unidentified can be chosen in a variety of different ways. For example, the one or more items to be unidentified could be randomly selected, selected based on file size, selected based on position in playlist, etc. Following the operation 620, the host computer synchronization processing 600 returns to repeat the decision 618 and subsequent operations.

When the decision 618 determines that the media device has sufficient capacity to store all of the identified media items, the identified media items and their associated media attributes are sent to the media device. Here, the remaining identified media items and their associated media attributes are sent (i.e., copied) from the host computer to the media device where they are to be stored. A playlist can also be sent 624 to the media device. The playlist can represent a new playlist or an updated version of a previously existing playlist. Before sending 624 the playlist to the media device, the playlist can be modified for use on the media device. Alternatively, the media device itself could update the playlist for use on the media device.

Additionally, although not illustrated in FIGS. 6A and 6B, according to another embodiment, the host computer synchronization processing 600 at operation 614 can also identify those of the media items on the media device that are not on the host computer. Then, the host computer can operate to interact with the media device to remove (e.g., delete) those media items stored on the media device that are not stored at the host server. Such additional processing would be performed after the operation 616 and prior to the decision 618 so that the storage capacity of the media device can be fully utilized.

The media device synchronization processing 500 and the host computer synchronization processing 600 interact to synchronize media items on the media device to those media items on the host computer. Such synchronization can consider all media items or can be limited to synchronizing only a subset of media content, such as media items pertaining to one or more playlists. The media attribute comparison provided by the invention is facilitated through the use of databases, both on the host computer and on the media device.

In one implementation, the host computer synchronization processing 600 can utilize an application resident on the host computer to perform the comparison and updating of the media items and their attributes between the host computer and the media device. One such application is iTunes, version 2.0, produced by Apple Inc. of Cupertino, Calif.

The various aspects or features of the invention described above can be used alone or in various combinations.

Although the media items of emphasis in several of the above embodiments where audio items (e.g., audio files or songs), the media items are not limited to audio items. For example, the media item can alternatively, pertain to videos (e.g., movies) or images (e.g., photos).

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different embodiments or implementations may yield one or more of the following advantages. One advantage of the invention is that a user is able to synchronize a media player with a host computer in a more sophisticated manner. Another advantage of the invention is that the amount of data transfer required for synchronization is reduced thus enabling faster synchronization. Still another advantage of the invention is that synchronization can be automatically initiated and performed upon connection of a media player to a host computer.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for synchronizing media contents of a media player with a host computer, said method comprising:
detecting connection of a media player to the host computer; and
automatically synchronizing media content between the media player and the host computer once the connection has been detected.

2. A method as recited in claim 1, wherein the connection is provided by a data link between the media player and the host computer.

3. A method as recited in claim 1, wherein the media player includes a media database storing player media information, and wherein the host computer includes a media database storing host media information.

4. A method as recited in claim 3, wherein said synchronizing is based on a comparison of the player media information with the host media information.

5. A method as recited in claim 1, wherein the media player is a portable media player.

6. A method as recited in claim 1, wherein the media player comprises an audio player, and wherein the media content includes at least audio files of songs.

7. A method as recited in claim 1, wherein the media player comprises a video player, and wherein the media content includes at least video files of videos.

8. A method as recited in claim 1, wherein the media player comprises an image viewer, and wherein the media content includes at least image files of images.

9. A method as recited in claim 1, wherein the media player stores player media information and the host computer stores host media information,
wherein said synchronizing is based on a comparison of the player media information with the host media information, and
wherein the player media information and the host media information pertain to attributes of media items corresponding to the media content.

10. A method as recited in claim 1, wherein said detecting of the connection of a media player to the host computer automatically occurs when a peripheral cable is physically connected between the media player and the host computer such that a data port of the media player couples to a data port of the host computer.

11. A method as recited in claim 10, wherein the media player is a pocket-sized media player.

12. A method as recited in claim 11, wherein the media player is an MP3 player, and wherein the media items include at least audio files of songs.

13. A method as recited in claim 1, wherein said synchronizing further synchronizes a list of media items between the media player and the host computer.

14. A method as recited in claim 13, wherein the list is a playlist.

15. A method as recited in claim 1, wherein the media player stores player media information and the host computer stores host media information, and wherein said synchronizing comprises:
reading the player media information from the media player;
comparing the player media information with the host media information from the host computer to produce comparison information, the player media information and the host media information comprise attributes of the media items;
determining which media items are to be copied between the media player and the host computer based on the comparison information; and
copying the determined media items to perform the synchronization.

16. A method as recited in claim 15, wherein the attributes include at least song title, album name and artist name.

17. A method as recited in claim 16, wherein the attributes further include quality characteristics.

18. A method as recited in claim 17, wherein the quality characteristics include at least one of bit rate, sample rate, equalization setting, volume adjustment, or time.

19. A method as recited in claim 15, wherein said synchronizing further comprises:
identifying media items that are to be removed from the media player based on the comparison information; and
removing the identified media items from the media player.

20. A method as recited in claim 19, wherein the identified media items are those media items on the media player but not on the host computer.

21. A method as recited in claim 19, wherein the play media information and the host media information pertain to attributes and quality characteristics of the media items.

22. A method as recited in claim 21, wherein the attributes include at least song title, album name and artist name, and wherein the quality characteristics include at least one of bit rate, sample rate, equalization setting, volume adjustment, start/stop and total time.

23. A portable media player, comprising:
a storage device that stores a plurality of media items;
a user input device that enables a user of said portable media player to at least select a particular media item from the plurality of media items;
a cache memory capable of storing at least one of the media items;
a media database that stores characteristics information for the media items stored to said storage device and said cache memory; and
a processor operatively connected to said storage device, said user input device, said cache memory and said media database, said processor controls said portable media player to store, remove and play the media items,
wherein said portable media player can interconnect with a host computer, and
wherein said processor automatically synchronizes the media items stored in said storage device with those media items stored at a host computer once said portable media player is connected with the host computer.

24. A portable media player as recited in claim 23, wherein said portable media player is connected with the host computer when a peripheral cable is physically connected between the portable media player and the host computer such that a data port of the portable media player couples to a data port of the host computer.

25. A method as recited in claim 24, wherein the synchronization further synchronizes at least one a list of media items between said portable media player and the host computer.

26. A method as recited in claim 25, wherein the list is a playlist.

27. A portable media player as recited in claim 24, wherein said processor performs the synchronization by performing at least the operations of: reading the player media information from the media player; comparing the player media information with the host media information from the host computer to produce comparison information; determining which media items are to be copied between the media player and the host computer based on the comparison information; and copying the determined media items to perform the synchronization.

28. A portable media player as recited in claim 27, wherein said comparing operates to further compare quality characteristics of media items.

29. A portable media player as recited in claim 28, wherein the quality characteristics include at least one of bit rate, sample rate, equalization setting, volume adjustment, start/stop and total time.

30. A portable media player as recited in claim 28, wherein said comparing operates to compare at least one of song title, album name and artist name.

31. A portable media player as recited in claim 23, wherein said portable media player is battery-operated.

32. A portable media player as recited in claim 31, wherein said portable media player is an audio player, and wherein the media items are songs.

33. A computer readable medium storing at least computer program code for synchronizing media contents of a media player with a host computer, said computer readable medium comprising:
computer program code for detecting connection of a media player to the host computer; and
computer program code for automatically synchronizing media content between the media player and the host computer once the connection has been detected.

34. A computer readable medium as recited in claim 33, wherein the media player includes a media database storing player media information, and wherein the host computer includes a media database storing host media information.

35. A computer readable medium as recited in claim 34, wherein said computer program code for synchronizing operates to compare the player media information with the host media information.

36. A computer readable medium as recited in claim 35, wherein the media player stores player media information and the host computer stores host media information, and
wherein said computer program code for synchronizing further comprises:
computer program code for reading the player media information from the media player;
computer program code for comparing the player media information with the host media information from the host computer to produce comparison information;
computer program code for determining which media items are to be copied between the media player and the host computer based on the comparison information; and
computer program code for copying the determined media items to perform the synchronization.

37. A computer readable medium as recited in claim 36, wherein the play media information and the host media information pertain to attributes of the media items.

38. A computer readable medium as recited in claim 37, wherein the attributes include at least song title, album name and artist name.

39. A computer readable medium as recited in claim 38, wherein the attributes further include quality characteristics.

40. A computer readable medium as recited in claim 39, wherein the quality characteristics include at least one of bit rate, sample rate, equalization setting, volume adjustment, or time.

41. A computer readable medium as recited in claim 36, wherein said computer program code for synchronizing further comprises:
computer program code for identifying media items that are to be removed from the media player based on the comparison information; and
computer program code for removing the identified media items from the media player.

42. A computer readable medium as recited in claim 41, wherein the identified media items are those media items on the media player but not on the host computer.

43. A computer readable medium as recited in claim 36, wherein the media player includes a first media database that stores the player media information, and the host computer includes a second media database that stores the host media information.

44. A computer readable medium as recited in claim 36, wherein the player media information and the host media information are obtained from metadata provided with the media items.
